(19) United States
(12) Patent Application Publication
(10) Pub. No.: US 2014/0099923 A1
(43) Pub. Date: Apr. 10, 2014

(54) SUBSCRIBER DEVICE UNLOCK

(71) Applicant: CELLCO PARTNERSHIP D/B/A VERIZON WIRELESS, Arlington, VA (US)

(72) Inventor: Bjorn O. Kalderen, South Orange, NJ (US)

(73) Assignee: Cellco Partnership d/b/a Verizon Wireless, Arlington, VA (US)

(21) Appl. No.: 13/648,057

(22) Filed: Oct. 9, 2012

(51) Int. Cl. H04W 12/06

(52) U.S. Cl. 455/411

(57) ABSTRACT

A mobile device includes a memory system and a processor. The memory system stores a local device identifier and the processor receives an unlock command from an unlock system. In response to receiving the unlock command, the processor compares the local device identifier to a remote device identifier stored in the unlock system. The processor executes the unlock command to unlock the mobile device if the local device identifier matches the remote device identifier.

### BACKGROUND

Users of mobile devices often store personal information in the mobile device. This personal information could include names of friends and family members, telephone numbers, the user's address, bank account information, credit card information, personal and business emails, and social network information. Securing the mobile device with password protection may protect this personal information in the event the mobile device is stolen. To enable password protection, the mobile device may prompt the user to provide a password. This prompt may occur during a setup process or at a later time when the user decides to password protect the mobile device. Once a password has been set, the user may manually lock the mobile device or the mobile device may lock automatically in certain circumstances, such as when the mobile device has been inactive for some amount of time. Once locked, the password must be entered to access any information stored in the mobile device. If the user forgets the password, the service provider must become involved for the user to regain access to the information stored on the mobile device.

### BRIEF DESCRIPTION OF THE DRAWINGS

FIG. 1 illustrates an exemplary system for synchronizing information between a mobile device and an unlock system and remotely unlocking the mobile device.

FIG. 2 is a block diagram of an exemplary mobile device.

FIG. 3 is a flowchart of an exemplary process that may be implemented by one or more mobile devices.

FIG. 4 is a flowchart of another exemplary process that may be implemented by one or more mobile devices.

### DETAILED DESCRIPTION

The exemplary system, mobile device, and processes described below help secure a mobile device after a theft. It is difficult for service providers to know the circumstances under which a mobile device changes hands. Device identifiers, used to identify a mobile device, most often change following a change in ownership of the mobile device. Legitimate changes in ownership typically involve the transfer of the mobile device with any locking features disabled (or with passwords necessary for unlocking provided as part of the transfer). Typically, if a device identifier changes while the mobile device is unlocked (e.g., by provision of an existing password), the service provider can safely assume that the mobile device was lawfully obtained by the new owner.

Thieves or unlawful recipients of mobile devices typically attempt to change the device identifier at some point to gain access to the mobile device's features. For mobile devices that are locked at the time the mobile device is stolen, the thief will have no choice but to attempt to change the device identifier while the mobile device is locked. One way thieves may do this is by placing a different subscriber identity module (SIM) card into the mobile device. Then, to circumvent the password protection and access the personal information stored on the mobile device, the thief will contact the service provider claiming to have forgotten the password to the mobile device. The mobile device described herein cannot be remotely unlocked under these circumstances. Rather, the mobile device can only be remotely unlocked if the device identifier is the same as it was at the time the mobile device was locked. With this feature, customer service representatives of the service provider are not left to decide whether the caller is the rightful owner of the mobile device and inadvertently unlock a stolen mobile device.

An exemplary mobile device includes a memory system, which stores a local device identifier, and a processor. The processor may receive an unlock command from an unlock system, which stores a remote device identifier. In response to receiving the unlock command, the processor compares the local device identifier to the remote device identifier. The processor executes the unlock command if the local device identifier matches the remote device identifier. The mobile device may further synchronize the local device identifier with the unlock system when the local device identifier changes while the mobile device is unlocked.

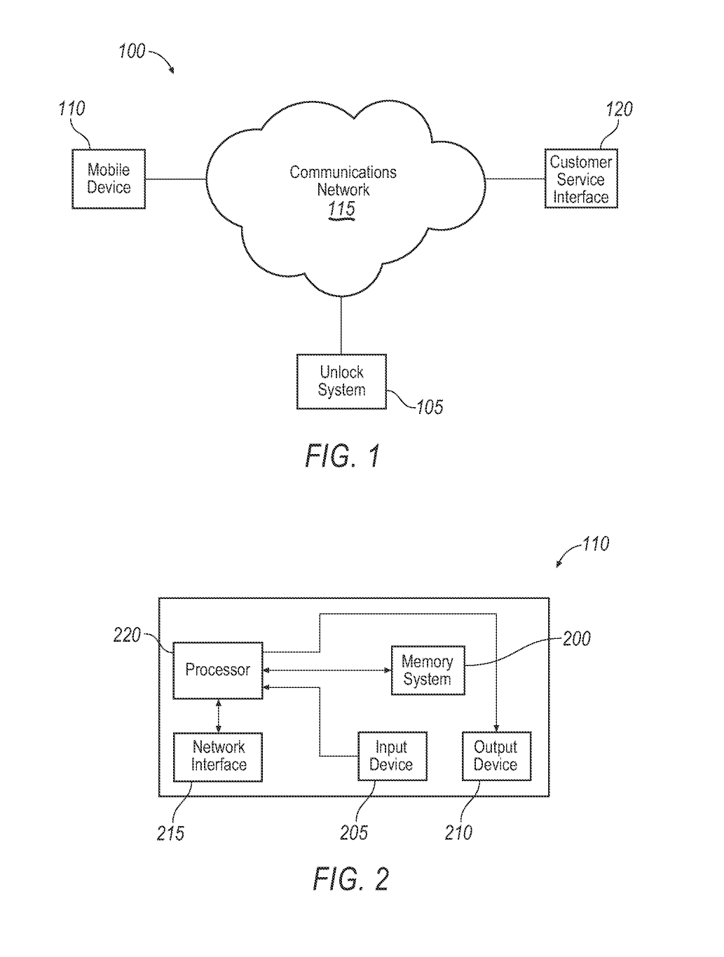

FIG. 1 illustrates an exemplary system 100 that may be used by a service provider to remotely unlock a mobile device under certain conditions that suggest the mobile device was lawfully obtained. The system 100 may take many different forms and include multiple and/or alternate components and facilities. While an exemplary system 100 is shown in FIG. 1, the exemplary components illustrated in FIG. 1 are not intended to be limiting. Indeed, additional or alternative components and/or implementations may be used.

As illustrated in FIG. 1, the system 100 may include a mobile device 110, an unlock system 105, a customer service interface 120, and a communications network 115.

The mobile device 110 may include any device configured to communicate over the communication network 115 and that includes a locking feature. The mobile device 110 may include a mobile phone, a tablet computer, a music player, etc., or any other portable electronic device. The locking feature may be implemented to prevent or limit use of the mobile device 110 until a password is received. The mobile device 110 may operate in accordance with an operating system that, either natively or through separate software, implements the locking feature. During a setup process or at the time the locking feature is enabled, the operating system may provide a user interface element that prompts a user of the mobile device 110 to provide the password that will unlock the mobile device 110. The password may take many forms, including text characters, gestures, voiceprints or other biometric indicators, depending on the capabilities of mobile device 110. Representations of the password may be stored by mobile device 110 for later comparison in order to perform the unlocking process.

The locking feature may cause the mobile device 110 to operate in two or more states, referred to below as the lock status. One state may include an unlocked state where all features of the mobile device 110 are available to the user. For instance, in the unlocked state, any information and all applications stored on the mobile device 110 may be available to the user. Some applications may, of course, require additional authentication even when the mobile device 110 is in the unlocked state. However, applications that require additional authentication may be available for user selection only when the mobile device 110 is in the unlocked state.

Another state may include a locked state. The operation of the mobile device 110 is limited while in the locked state. For instance, while in the locked state, the mobile device 110 may be configured to accept a password to unlock the mobile device 110. No information or applications stored on the mobile device 110 may be available to the user while the mobile device 110 is in the locked state. The locked state may, in some instances, allow limited use of the mobile device 110. For instance, if the mobile device 110 includes the capability to make calls over a telecommunications network, the locked state may permit emergency calls without providing the password.

The locking feature may be enabled manually in response to a user input, such as when the user presses a button on the mobile device 110 or makes a particular selection within the operating system user interface or other software. Alternatively or in addition, the locking feature may be enabled after a predetermined amount of time of inactivity. The predetermined amount of time may be selected by the user at the time the locking feature is enabled or at a later time. A default amount of time may be set until the user selects a new predetermined amount of time.

The unlock system 105 may include any device or number of devices configured to store information about any number of mobile devices 110. For instance, the unlock system 105 may be configured to store one or more device identifiers for each of the one or more mobile devices 110 supported by the service provider. The unlock system 105 may use any number of databases or other types of data stores to store the device identifiers. Each device identifier may include a unique number or code associated with the mobile device 110. For instance, the device identifiers may include or be based on any one or combination of the following: an MSISDN number, a mobile device number (MDN), an Internet Protocol (IP) address, an electronic serial number (ESN), an international mobile equipment identity (IMEI), a media access control (MAC) address, or a mobile equipment identifier (MEID). Some of these identifiers, such as the MSISDN number and the mobile device number can be ported between devices (for example, when a user replaces one device for another). Other identifiers are generally permanently associated with the mobile device, such as the ESN, IMEI, or MEID. The unlock system 105 may include one or more pairings between a device identifier that can be ported, such as the MSISDN or MDN, and a device identifier that cannot be ported, such as such as the ESN, IMEI, or MEID.

The version of a device identifier stored at the unlock system 105 may be referred to as the “remote device identifier.” The device identifier may also be stored on the mobile device 110, as discussed in further detail below. The version of the device identifier stored on the mobile device 110 may be known as the local device identifier, and at least one component (e.g., the ported component) of the local device identifier (e.g., the MSISDN number or the MDN) may be received by the mobile device 110 via a subscriber identity module (SIM) card connected to the mobile device.

The unlock system 105 may be configured to receive communications from one or more mobile devices 110 and to transmit commands or other information to one or more mobile devices 110. For instance, the unlock system 105 may be configured to transmit an unlock command. When the unlock command is executed by the mobile device 110, the lock status of the mobile devices 110 changes from a locked state to an unlocked state. Whether the unlock command is executed, however, is determined by the mobile device 110, as discussed in greater detail below. The mobile device 110 may transmit an indication of a result of the unlock command to the unlock system 105. The unlock system 105 may be further configured to communicate with the customer service interface 120, for example, in order to receive instructions to transmit unlock commands to particular mobile devices 110, or to transmit indications of results of the unlock commands.

A customer service interface 120 may include any device or number of devices configured to provide an interface to users of mobile devices 110 to manage their devices and services. Customer service interface 120 may include systems that provide various forms of interfaces for receipt of customer communications, such as a voice interface (e.g., call center with live agents or interactive voice response capabilities), a visual interface (e.g., chat, texting, email, instant messaging, or other text-based communications), a machine interface (e.g., web services) or other known interfaces. Customer service interface 120 may provide the capability to request an unlock command be issued by the unlock system 105. As one example, a person in possession of the mobile device 110 may call the customer service interface 120, and request to have the mobile device 110 unlocked. A customer service representative may then cause the customer service interface 120 to transmit an unlock request to the unlock system 105 so that the unlock system 105 will transmit the unlock command to the mobile device 110. One or more device identifiers associated with the mobile device 110 may be included in the unlock request, in order for the unlock system 105 to identify the proper mobile device 110 for the unlock command. The unlock system 105 may also communicate a result of the unlock request to the customer service interface 120, which may then be communicated to the user via the user interface being employed.

The communication network 115 may be configured to facilitate communication between any number of mobile devices 110 and the unlock system 105. The communication network 115 may include one or more networks, e.g., a telecommunications network maintained by a service provider or one or more public or private data networks. The communications network 115 may also be configured to facilitate communication between the unlock server 105 and the customer service interface 120, in order to permit the exchange of communications such as those described herein.

FIG. 2 illustrates some components of an exemplary mobile device 110. The mobile device 110, as illustrated, includes a memory system 200, an input device interface 205, an output device interface 210, a network interface 215, and a processor 220.

The memory system 200 may be configured to store electronic information and to make such information available to other components of the mobile device 110. The memory system 200 may include any number of volatile or non-volatile memory storage modules that store the operating system, various applications, and other software used by the mobile device 110. The memory system 200 may also store information that may be accessed by and viewed using the mobile device 110. The memory system 200 may, in some instances, store the device identifier associated with the mobile device 110. As previously mentioned, the version of the device identifier stored in the memory system 200 may be known as the local device identifier. The memory system 200 may, in some instances, receive at least a ported component of the device identifier from a SIM card connected to the mobile device 110. Alternatively, the mobile device 110 may be programmed with the ported component, and the ported component may be stored in the memory system 200. In some exemplary approaches, the SIM card itself may act as the memory system 200 or otherwise physically embody the local device identifier.

The input device interface 205 may include any device configured to allow the mobile device 110 to receive inputs from the user through, e.g., an input device. Some input devices may be part of the mobile device 110 while others may be peripheral devices. The input device interface 205 may therefore be configured to receive signals or other inputs from a touchscreen, keyboard, number pad, scroll button, etc. Some types of inputs may include the password to unlock the mobile device 110, telephone numbers, names and addresses, selections of applications, selections of menu items, webpage URLs, social network information, etc. Inputs received by the input device interface 205 may be transmitted to or otherwise received by the processor 220, as discussed in greater detail below.

The output device interface 210 may include any device configured to output signals to output devices so that information may be perceived by the user of the mobile device 110. For instance, the output device interface 210 may be configured to output signals to a display screen, printer, speakers, etc. The output device interface 210 may be configured to receive signals generated by the processor 220 and transmit corresponding signals to one or more output devices that are part of or peripheral to the mobile device 110 for presentation to the user or further processing by the output device.

The network interface 215 may include any number of devices configured to facilitate communication with other devices over the communication network 115. For instance, the network interface 215 may include an antenna for wireless communication. The network interface 215 may alternatively or additionally include hardware for wired communication via the communication network 115.

The processor 220 may include any device configured to process signals in accordance with the operating system or any other software stored in the memory system 200. The processor 220 may, for instance, be configured to receive indications one or more inputs, provided by the user, from the input device interface 205. If the mobile device 110 is in the locked state, the processor 220 may, in accordance with the component implementing the locking feature, cause the provision of a user interface including a prompt for the user to provide the current password. The processor 220 may receive the indications of the password input by the user via the input device interface 205, and perform a matching process against the current password as stored in the mobile device 110. If the provided password is the same as the current password, the processor 220 may determine that the user is authenticated and cause the lock status to change from the locked state to the unlocked state. The processor 220 may further cause the lock status of the mobile device 110 to change from an unlocked state to a locked state in response to an input received at the input device interface 205.

Moreover, the processor 220 may use the user input to determine the lock status of the mobile device 110. If the user input suggests the user's desire to change the lock status of the mobile device 110 to a locked state, the processor 220 may conclude the mobile device 110 is locked. If, however, the user provided the password since indicating a desire to lock the mobile device 110, the processor 220 may determine that the mobile device 110 is or should be unlocked. In accordance with the instructions set forth by the operating system, the processor 220 may be configured to identify changes in the lock status. For instance, the processor 220 may be configured to identify when the lock status changes from the locked state to the unlocked state and from the unlocked state to the locked state.

In one exemplary approach, the processor 220 may identify the lock status or a change in the lock status by querying the operating system. For instance, the processor 220 may continually query the operating system to determine the lock status, or in one possible approach, the processor 220 may query the operating system to determine the lock status in response to one or more events. Such events may include the receipt of a user input, in which case the processor 220 may query the operating system for the lock status before executing the user input. The processor 220 may ignore some types of user inputs received while the mobile device 110 is locked. Some types of inputs the processor 220 may accept while the mobile device 110 is locked may include power on or power off commands, commands related to disabling the locking feature (e.g., providing the password), and commands related to making an emergency phone call if the mobile device 110 supports such a feature.

In addition to receiving and processing signals transmitted within the mobile device 110, the processor 220 may be further configured to receive and process signals received from other, remote devices. The processor 220 may be configured to receive communications from remote devices via the network interface 215. Using the network interface 215, the processor 220 may be configured to receive signals transmitted by the unlock system 105 over, e.g., the communication network 115. For instance, the processor 220 may be configured to receive the unlock command from the unlock system 105. The unlock command may be transmitted to the mobile device 110, for example, after the user calls a customer service representative after having forgotten his or her password. The customer service representative may cause the customer service interface 120 to communicate with the unlock system 105 to transmit the unlock command to the mobile device 110.

The processor 220 is configured to only execute the unlock command if the local device identifier, and in particular the ported component of the local device identifier, is the same as it was at the time the mobile device 110 was locked. A change in the ported component of the local device identifier while the mobile device 110 was in the locked state could suggest that the mobile device 110 was stolen. Therefore, the processor 220 may be configured to interpret changes in the device identifier while the mobile device 110 is in the locked state as suggestive of a possible theft or otherwise unlawful transfer of ownership of the mobile device 110. To prevent unlocking the mobile device 110 under such circumstances, in response to receiving the unlock command, the processor 220 may compare the local device identifier to the remote device identifier, which as discussed above is stored at the unlock system 105. If the processor 220 determines that the remote device identifier matches the local device identifier, the processor 220 may conclude that the user is likely the rightful owner of the mobile device 110 and execute the unlock command. If, however, the processor 220 determines that the local device identifier is different from the remote device identifier, the processor 220 may ignore the unlock command.

To determine the local device identifier, the processor 220 may query the memory system 200 and may query the unlock system 105 to retrieve the remote device identifier. In one possible implementation, the query identifies the mobile device 110 using, e.g., the permanent component of the device identifier, and requests the remote device identifier stored in the unlock system 105 that is associated with the mobile device 110. Each mobile device 110 may be associated with a memory location in a database stored in the unlock system 105. The processor 220 may be configured to include the memory location associated with the mobile device 110 in the query to the unlock system 105. The processor 220 may be configured to receive the remote device identifier transmitted in response to the query via, e.g., the network interface 215.

The processor 220 may, as mentioned above, recognize legitimate changes in ownership of the mobile device 110. In such situations, the previous owner may transfer ownership of the mobile device 110 while the mobile device 110 is unlocked. The new owner may indicate a change in ownership by replacing a subscriber identity module (SIM) card in the mobile device 110 or by notifying the service provider of the change in ownership while the mobile device 110 is unlocked. This may result in the mobile device 110 receiving a new ported component of the device identifier. Following a change in ownership, the processor 220 may be configured to send an updated or new device identifier, including at least the new ported component, to the unlock system 105 so that the unlock system 105 may update the remote device identifier with the new ported component. For instance, the processor 220 may be configured to detect receipt of a new SIM card with the updated device identifier.

If a change in ownership has been detected by the processor 220, and if that change in ownership is believed by the processor 220 to be lawful, the next time the mobile device 110 is changed from the unlocked state to the locked state, the processor 220 may be configured to determine the new device identifier from, e.g., the SIM card. The processor 220 may be further configured to store the new device identifier in the memory system 200 as a new local device identifier and to transmit the new device identifier to the unlock system 105. Once received by the unlock system 105, the new device identifier may replace the remote device identifier stored in the unlock system 105. Thereafter, the new device identifier becomes the remote device identifier. Because the remote device identifier and local device identifier are synchronized in this manner, the unlock system 105 is aware of the change in ownership of the mobile device 110 and has the appropriate information to authenticate the mobile device 110 should the new owner forget the password required to access the mobile device 110.

In general, computing systems and/or devices, such as the mobile device 110, customer service interface 120 and unlock system 105, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

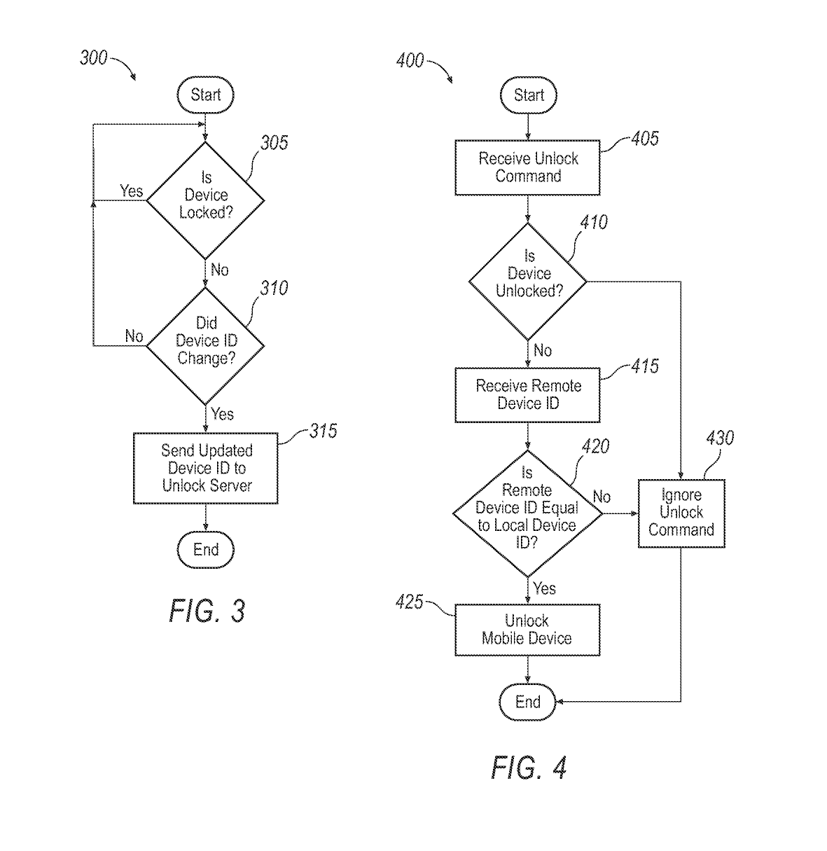

FIG. 3 illustrates an exemplary process 300 of synchronizing information, such as the device identifier, between the mobile device 110 and the unlock system 105. In one possible implementation, the process 300 may be implemented by the mobile device 110 to synchronize the local device identifier stored in the memory system 200 with the remote device identifier stored in the unlock system 105. As set forth below, the processor 220 synchronizes the device identifier if the mobile device 110 is unlocked at the time the device identifier changes.

At decision block 305, the processor 220 may determine a lock status of the mobile device 110. One possible lock status includes a locked state, which generally means that the features of the mobile device 110 are unavailable or available only for very limited purposes, while another possible locked status includes an unlocked state, which generally suggests that the features of the mobile device 110 are available for use. One way for the processor 220 to determine the lock status of the mobile device 110 is to query the operating system for the lock status. Alternatively, the processor 220 may rely upon inputs received from the user indicating that the mobile device 110 is locked or unlocked. If the mobile device 110 is in the locked state, the process 300 may return to block 305 to wait for a change in the lock status from, e.g., the locked state to the unlocked state. If the mobile device 110 is in the unlocked state, the process 300 may continue at block 310.

At decision block 310, the processor 220 may determine whether the device identifier associated with the mobile device 110 has changed. For instance, if ownership of the mobile device is transferred, the new owner may change a SIM card, attempt to reprogram a ported component of the device identifier, or contact a service provider to change the ported component of the device identifier. The new SIM card may contain the updated device identifier or a customer service representative of the service provider may transmit the updated device identifier to the mobile device 110. The updated device identifier may include just the ported component or may include the combined ported component (MSISDN, MDN, etc.) with a permanent component (IMEI, MEID, ESN, etc.). The processor 220 may be configured to detect either of these types of changes in the device identifier and replace the local device identifier from the previous owner with the updated device identifier. That is, the processor 220 may be configured to store the updated device identifier in the memory system 200 as the new local device identifier. If a change in the device identifier is detected by the processor 220, the process 300 may continue at block 315. If no change is detected, the process 300 may return to block 305.

At block 315, the processor 220 may send the updated device identifier, or at least the ported component of the updated device identifier, to the unlock system 105. In one possible approach, the processor 220 may transmit the updated device identifier to the network interface 215 with instructions to the network interface 215 to send the updated device identifier to the unlock system 105 over the communication network 115.

The process 300 may end after block 315.

FIG. 4 illustrates another exemplary process 400 that may be implemented by the mobile device 110. The process 400 of FIG. 4 may be used to, e.g., determine whether to unlock the mobile device 110 in response to receiving the unlock command from the unlock system 105. In some instances, the process 400 may prevent customer service representatives of a service provider from unlocking stolen mobile devices 110.

At decision block 405, the processor 220 may receive an unlock command from the unlock system 105. The unlock command may instruct the mobile device 110 to unlock. In some circumstances, the unlock command may also reset the password previously set to disable the locking feature. The unlock system 105 may transmit the unlock command to the mobile device 110 in response to instructions received from the customer service interface 120, for example, as directed by a customer service representative of the service provider servicing the mobile device 110. The customer service representative may initiate the unlock command in response to a customer request. The customer may make such a request if the customer forgot the password to unlock the mobile device 110. Alternatively, a thief may make such as request to gain access to the information stored in the mobile device 110.

At decision block 410, the processor 220 may determine the lock status of the mobile device 110. The lock status may be determined by querying the operating system or by analyzing user inputs, as discussed above. If the mobile device 110 is in a locked state, the process 400 may continue at block 415. If the mobile device 110 is in the unlocked state, the process 400 may continue at block 430.

At block 415, the processor 220 may receive the remote device identifier from the unlock system 105. In one possible approach, the remote device identifier may be transmitted with the unlock command. Alternatively, the remote device identifier may be transmitted in a separate communication from the unlock command. The unlock system 105 may transmit the remote device identifier automatically or in response to a query by the processor 220.

At decision block 420, the processor 220 may compare the remote device identifier to the local device identifier, which as discussed above may be stored in the memory system 200. For instance, the processor 200 may compare the ported component of the local device identifier to the ported component of the remote device identifier. If the remote device identifier is equal to the local device identifier, as interpreted by the processor 220 based on the respective ported components, the process 400 may continue at block 425. If the processor 220 determines, however, that the ported component of the remote device identifier is different from the ported component of the local device identifier, the process 400 may instead continue at block 430.

At block 425, the processor 220 may execute the unlock command to unlock the mobile device 110. At this point in the process 400, the processor 220 has determined that the device identifier was associated with the mobile device 110 while the mobile device 110 was unlocked. This suggests that the mobile device 110 was likely lawfully obtained by the current user.

At block 430, the processor 220 may ignore the unlock command. To arrive at block 430, the processor 220 may have determined that the mobile device 110 was locked at the time the device identifier changed, which suggests that the mobile device 110 may have been stolen from its lawful owner and the thief or someone who received the mobile device 110 from the thief may have contacted the service provider to have the mobile device 110 unlocked. The processor 220 may therefore ignore the unlock command to protect the security of the information stored in the mobile device 110.

The process 400 may end after block 425 or block 430.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A mobile device comprising:
a memory system configured to store a local device identifier;
a processor configured to receive an unlock command from an unlock system storing a remote device identifier and, in response to receiving the unlock command, compare the local device identifier to the remote device identifier;
wherein the processor is configured to execute the unlock command if the local device identifier matches the remote device identifier.

2. A mobile device as set forth in claim 1, wherein the processor is configured to ignore the unlock command if the local device identifier is different from the remote device identifier.

3. A mobile device as set forth in claim 1, wherein the processor is configured to query the unlock system for the remote device identifier.

4. A mobile device as set forth in claim 1, wherein the processor is configured to determine a lock status.

5. A mobile device as set forth in claim 4, further comprising an input device interface configured to receive a user input, and wherein the processor is configured to change the lock status based on the user input.

6. A mobile device as set forth in claim 4, wherein the processor is configured to transmit the local device identifier to the unlock system based at least in part on the lock status.

7. A mobile device as set forth in claim 4, further comprising an operating system, and wherein the processor is configured to query the operating system for the lock status.

8. A mobile device as set forth in claim 4, wherein the processor is configured to detect whether the local device identifier has changed.

9. A mobile device as set forth in claim 8, wherein the processor is configured to transmit a new local device identifier to the unlock system.

10. A mobile device as set forth in claim 9, wherein the lock status includes at least one of a locked state and an unlocked state, and wherein the processor is configured to identify whether the lock status has changed from the unlocked state to the locked state.

11. A mobile device as set forth in claim 10, wherein the processor is configured to query the memory system for the local device identifier each time the lock status changes from the unlocked state to the locked state.

12. A method comprising:
receiving an unlock command from an unlock system;
receiving a remote device identifier from the unlock system;
comparing the remote device identifier received from the unlock system to a local device identifier; and
executing the unlock command if the remote device identifier is the same as the local device identifier and ignoring the unlock command if the remote device identifier is different from the local device identifier.

13. A method as set forth in claim 12, further comprising determining a lock status of a mobile device.

14. A method as set forth in claim 13, wherein determining the lock status of the mobile device includes querying an operating system of the mobile device for the lock status.

15. A method as set forth in claim 13, further comprising detecting whether the local device identifier has changed.

16. A method as set forth in claim 15, further comprising transmitting an updated local device identifier to the unlock system if the local device identifier has changed.

17. A method as set forth in claim 15, wherein the lock status includes at least one of a locked state and an unlocked state, and wherein detecting whether the local device identifier has changed occurs in response to a change in the lock status from the unlocked state to the locked state.

18. A method as set forth in claim 12, wherein the unlock command is initiated by a customer service representative in response to a user inquiry.

19. A method as set forth in claim 12, further comprising querying the unlock system for the remote device identifier.

20. A method comprising:
detecting a change in a lock status of a mobile device from an unlocked state to a locked state;
detecting, at a mobile device, whether a local device identifier unique to the mobile device has changed;
transmitting an updated local device identifier to an unlock system if the local device identifier has changed;
receiving an unlock command from an unlock system;
receiving a remote device identifier from the unlock system, wherein the remote device identifier is associated with the mobile device;
comparing the remote device identifier received from the unlock system to the local device identifier; and
executing the unlock command if the remote device identifier is the same as the local device identifier and ignoring the unlock command if the remote device identifier is different from the local device identifier.
